(19) United States
(12) Patent Application Publication
(10) Pub. No.: US 2003/0133586 A1
(43) Pub. Date: Jul. 17, 2003

(54) Loudspeaker with a wire stablizer

(76) Inventor: Joseph Ko, Taipei (TW)

Correspondence Address: LADAS & PARRY, 224 SOUTH MICHIGAN AVENUE, SUITE 1200, CHICAGO, IL, 60604, US

(21) Appl. No.: 10/043,916

(22) Filed: Jan. 11, 2002

(51) Int. Cl. H04R 1/00; H04R 9/06; H04R 11/02

(52) U.S. Cl. 381/410; 381/409

(57) ABSTRACT

A loudspeaker includes a magnet assembly defining an air gap, a voice coil disposed in the air gap, a diaphragm coupled to the voice coil for vibrating with the voice coil, a flexible spider connected to the voice coil and the diaphragm, a pair of spaced apart speaker tinsel conductors spaced apart from the spider and respectively connected to two connecting ends of the voice coil, and a wire stabilizer interconnecting the speaker tinsel conductors so as to prevent twisting and collision between the speaker tinsel conductors during vibration of the voice coil and the diaphragm.

### BACKGROUND OF THE INVENTION

1. Field of the Invention

This invention relates to a loudspeaker including a wire stabilizer for preventing twisting and roping of speaker tinsel conductors in the loudspeaker.

2. Description of the Related Art

FIG. 1 illustrates a conventional loudspeaker 2 including a magnet assembly 20 that defines an air gap for receiving a voice coil 25 which is magnetically associated with the magnet assembly 20 so as to vibrate upon receiving an electrical signal. A truncated conical diaphragm 24 is coupled to the voice coil 25 for vibrating with the voice coil 25. A spider 23 (or inner suspension) is connected to the diaphragm 24 and the voice coil 25 so as to maintain positions of the diaphragm 24 and the voice coil 25 without hindering free vibration of the diaphragm 24 and the voice coil 25. A pair of spaced apart speaker tinsel conductors 21 (only one is shown) are fixed on a truncated conical diaphragm support 22, and are connected to two connecting ends of the voice coil 25 so that when the voice coil 25 receives an electrical signal from a signal source (not shown) via the speaker tinsel conductors 21, the voice coil 25 will vibrate together with the diaphragm 24 and the spider 23, thereby producing sound. Since the speaker tinsel conductors 21 will vibrate along with vibration of the voice coil 25 and the diaphragm 24, the speaker tinsel conductors 21 tend to swing, thereby resulting in undesired twisting and roping (or collision) of the speaker tinsel conductors 21.

In order to overcome the aforesaid twisting and roping problems, it has been proposed heretofore to extend and bond the speaker tinsel conductors 21 to a grooved surface of the spider 23 prior to connecting with the voice coil 25, as best illustrated in FIG. 2. Assembly of the speaker tinsel conductors 21 and the spider 23 is carried out by attaching the speaker tinsel conductors 21 on a fabric with the use of an adhesive, impregnating assembly of the fabric and the speaker tinsel conductors 21 with a resin, and thermally molding the assembly to the spider 23 with the speaker tinsel conductors 21 attached thereon. The process of forming the aforesaid assembly is complex and costly.

### SUMMARY OF THE INVENTION

Therefore, the object of the present invention is to provide a loudspeaker with a wire stabilizer that is capable of overcoming the aforementioned drawbacks.

According to one aspect of the present invention, a loudspeaker comprises: a magnet assembly; a vibration unit operably associated with the magnet assembly so as to vibrate upon receiving an electrical signal; a spider connected to the vibration unit so as to maintain proper position of the vibration unit without hindering free vibration of the vibration unit; a pair of spaced apart speaker tinsel conductors free of contact with the spider and electrically connected to the vibration unit; and a fastener that interconnects the speaker tinsel conductors so as to prevent twisting and collision between the speaker tinsel conductors during vibration of the vibration unit.

According to another aspect of the present invention, there is provided a method for preventing twisting and collision between a pair of spaced apart speaker tinsel conductors in a loudspeaker which includes a magnet assembly, a-vibration unit operably associated with the magnet assembly so as to vibrate upon receiving an electrical signal, and a spider connected to the vibration unit so as to maintain proper position of the vibration unit without hindering free vibration of the vibration unit. The speaker tinsel conductors are free of contact with the spider and are electrically connected to the vibration unit. The method comprises the step of interconnecting the speaker tinsel conductors using a fastener in the loudspeaker in a manner that the fastener is separated from the vibration unit and the spider.

### BRIEF DESCRIPTION OF THE DRAWINGS

In drawings which illustrate embodiments of the invention,

FIG. 1 is a schematic sectional view of a conventional loudspeaker;

FIG. 2 is a fragmentary sectional view of another conventional loudspeaker;

FIG. 3 is a schematic sectional view of a loudspeaker embodying this invention;

FIG. 4 is a cutaway top view to illustrate how a pair of speaker tinsel conductors are stabilized by a wire stabilizer of the loudspeaker of FIG. 3;

FIG. 5 is a perspective view to illustrate a first embodiment of the wire stabilizer of FIG. 4;

FIG. 6 is a perspective view to illustrate a second embodiment of the wire stabilizer of FIG. 4;

FIG. 7 is a perspective view to illustrate a third embodiment of the wire stabilizer of FIG. 4; and

FIG. 8 is a cutaway top view to illustrate a fourth embodiment modified from the loudspeaker of FIG. 4.

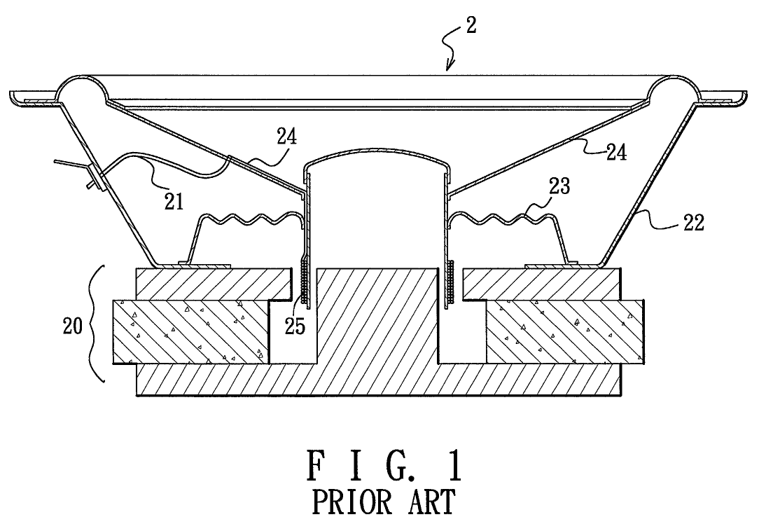

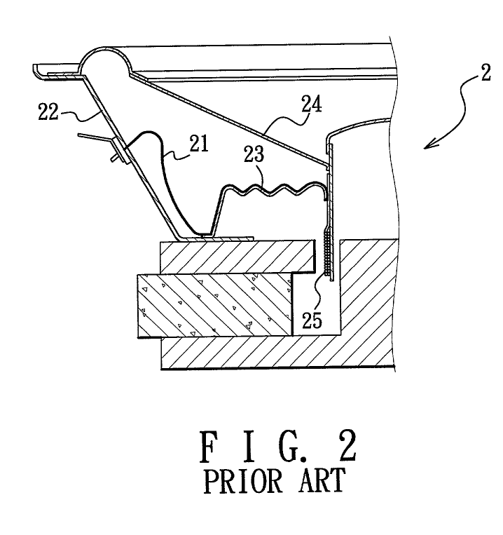

### DETAILED DESCRIPTION OF THE PREFERRED EMBODIMENTS

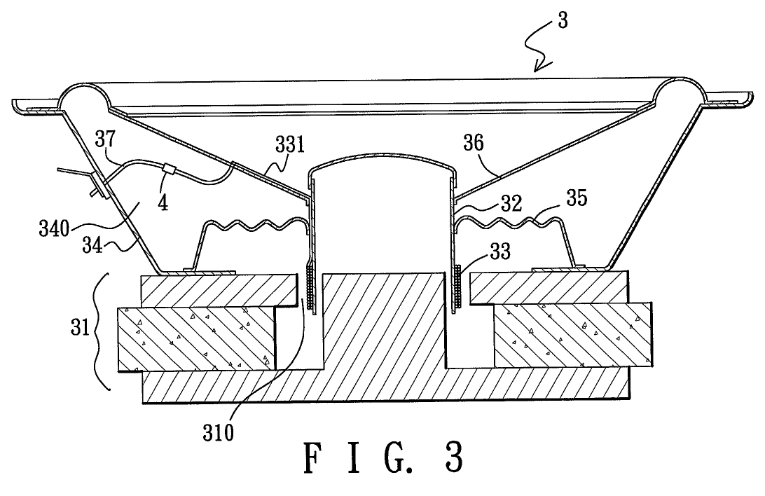

FIGS. 3 to 5 illustrate a first embodiment of a loudspeaker 3 that includes: a magnet assembly 31 defining an air gap 310; a vibration unit operably associated with the magnet assembly 31 so as to vibrate upon receiving an electrical signal, the vibration unit including a voice coil 33 disposed around a tubular member 32 in the air gap 310 so as to be associated magnetically with the magnet assembly 31, and having two connecting ends 331, the vibration unit further including a truncated conical diaphragm 36 coupled to the voice coil 33 for vibrating with the voice coil 33; a flexible spider 35 connected to the voice coil 33 and the diaphragm 36 in a known manner so as to maintain proper positions of the voice coil 33 and the diaphragm 36 without hindering free vibration of the voice coil 33 and the diaphragm 36; a truncated conical diaphragm support 34 connected to and cooperating with the diaphragm 36 and the magnet assembly 31 to define thereamong an enclosing space 340 that receives the spider 35; a pair of spaced apart speaker tinsel conductors 37, each of which has a section extending between and supported on the diaphragm support 34 and the diaphragm 36 so as to be suspended in the enclosing space 340, the speaker tinsel conductors 37 being free of contact with the spider 35 and being connected respectively and electrically to the connecting ends 331 of the voice coil 33 so as to electrically connect the voice coil 33 to a signal source, such as an amplifier (not shown); and a wire stabilizer including at least a fastener 4 that is disposed in the enclosing space 340 and that interconnects the sections of the speaker tinsel conductors 37 so as to prevent twisting and collision between the speaker tinsel conductors 37 during vibration of the voice coil 33 and the diaphragm 36.

Preferably, the fastener 4 is made of an insulator material and is separated from the spider 35, the diaphragm 36, the voice coil 33, and the diaphragm support 34.

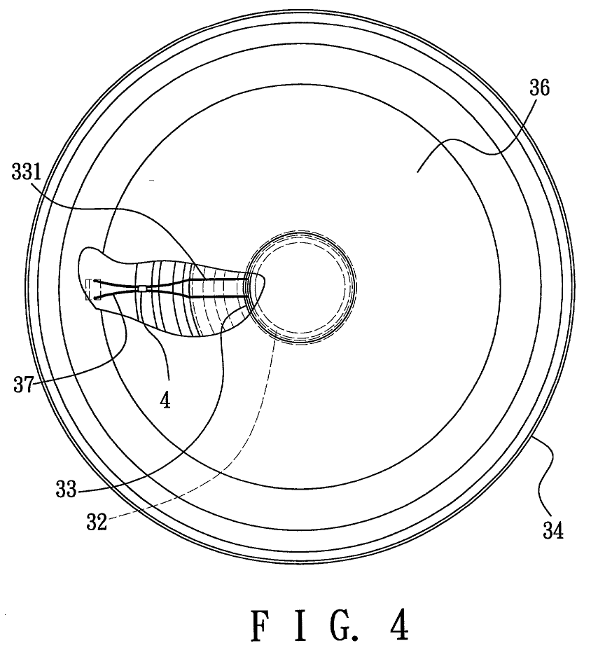

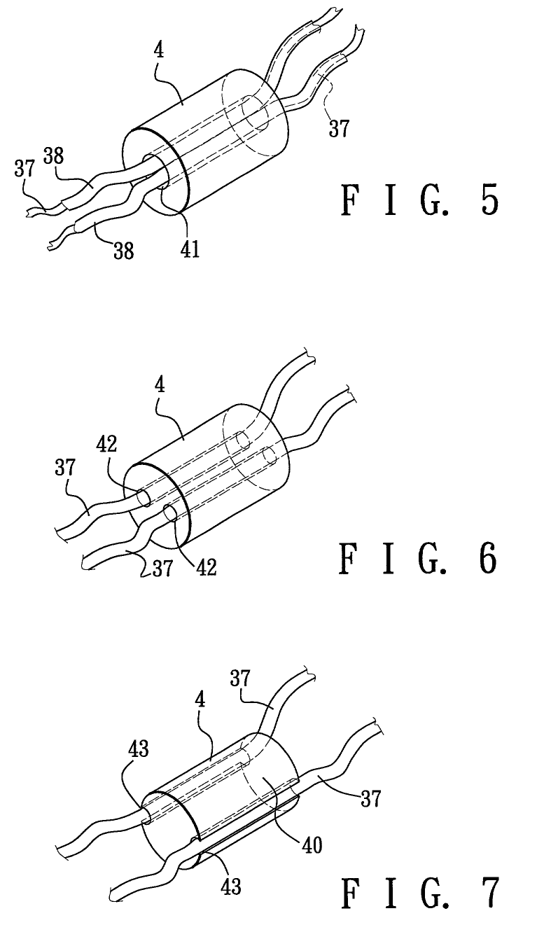

In this embodiment, the fastener 4 is a cylindrical body having two opposite ends and formed with a retaining channel 41 (see FIG. 5) that extends in a longitudinal direction from one of the opposite ends to the other of the opposite ends. The section of each of the speaker tinsel conductors 37 is sheathed with an insulator sheath 38. The sections of the speaker tinsel conductors 37 extend fittingly in the longitudinal direction through the retaining channel 41.

Referring to FIG. 6, the fastener 4 of a second embodiment is shown to be similar to the previous embodiment of FIG. 5, except that two spaced apart retaining channels 42 are formed therein and extend in the longitudinal direction from one of the opposite ends to the one of the opposite ends. The sections of the speaker tinsel conductors 37 extend in the longitudinal direction through the retaining channels 42, respectively.

Referring to FIG. 7, the fastener 4 of a third embodiment is shown to be similar to the previous embodiment of FIG. 5, except that two spaced apart retaining channels 43 are indented inwardly of an outer surface 40 of the fastener 4, and extend in the longitudinal direction from one of the opposite ends to the other of the opposite ends. The sections of the speaker tinsel conductors 37 extend in the longitudinal direction through the retaining channels 43, respectively.

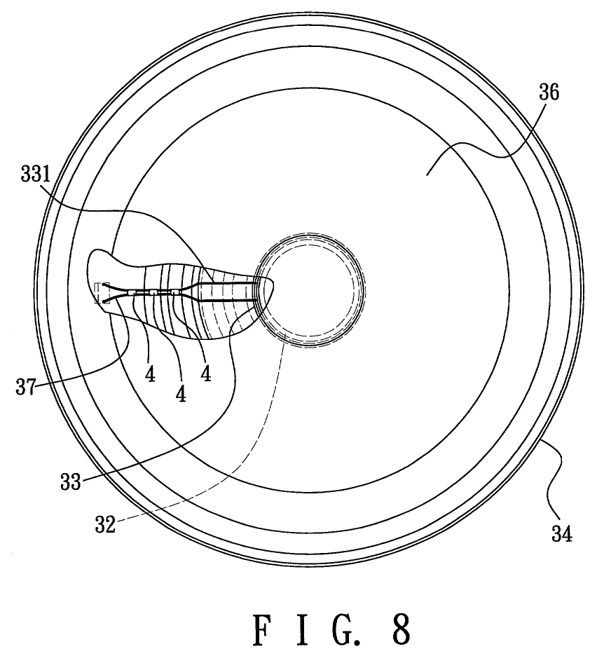

FIG. 8 illustrates a fourth embodiment that is a modification of the first embodiment. This embodiment includes a plurality of the fasteners 4 that interconnect the sections of the speaker tinsel conductors 37.

With the inclusion of the wire stabilizer, the drawbacks associated with the prior art can be eliminated.

With the invention thus explained, it is apparent that various modifications and variations can be made without departing from the spirit of the present invention. It is therefore intended that the invention be limited only as recited in the appended claims.

I claim:

1. A loudspeaker, comprising:
a magnet assembly;
a vibration unit operably associated with said magnet assembly so as to vibrate upon receiving an electrical signal;
a spider connected to said vibration unit so as to maintain proper position of said vibration unit without hindering free vibration of said vibration unit;
a pair of spaced apart speaker tinsel conductors free of contact with said spider and electrically connected to said vibration unit; and
a fastener that interconnects said speaker tinsel conductors so as to prevent twisting and collision between said speaker tinsel conductors during vibration of said vibration unit.

2. The loudspeaker of claim 1, wherein said fastener is separated from said vibration unit and said spider.

3. The loudspeaker of claim 1, wherein said fastener is a cylindrical body having two opposite ends and formed with a retaining channel that extends in a longitudinal direction from one of said opposite ends to the other of said opposite ends, each of said speaker tinsel conductors being sheathed with an insulator sheath and extending fittingly through said retaining channel in said longitudinal direction.

4. The loudspeaker of claim 1, wherein said fastener is a cylindrical body having two opposite ends and formed with two spaced apart retaining channels that extend in a longitudinal direction from one of said opposite ends to the other of said opposite ends, said speaker tinsel conductors extending in said longitudinal direction through said retaining channels, respectively.

5. The loudspeaker of claim 1, wherein said fastener is a cylindrical body having two opposite ends, and an outer surface that is formed with two opposing retaining channels indented inwardly of said outer surface and extending in a longitudinal direction from one of said opposite ends to the other of said opposite ends, said speaker tinsel conductors extending in said longitudinal direction through said retaining channels, respectively.

6. A loudspeaker, comprising:
a magnet assembly defining an air gap;
a voice coil disposed in said air gap and magnetically associated with said magnet assembly, said voice coil having two connecting ends;
a diaphragm coupled to said voice coil for vibrating with said voice coil;
a flexible spider connected to said voice coil and said diaphragm so as to maintain proper positions of said voice coil and said diaphragm without hindering free vibration of said voice coil and said diaphragm;
a diaphragm support connected to and cooperating with said diaphragm and said magnet assembly to define thereamong an enclosing space that receives said spider;
a pair of spaced apart speaker tinsel conductors, each of which has a section extending between and supported on said diaphragm support and said diaphragm so as to be suspended in said enclosing space, said speaker tinsel conductors being spaced apart from said spider, and being respectively connected to said connecting ends of said voice coil; and
a wire stabilizer including at least a fastener that is disposed in said enclosing space and that interconnects said sections of said speaker tinsel conductors so as to prevent twisting and collision between said speaker tinsel conductors during vibration of said voice coil and said diaphragm.

7. The loudspeaker of claim 6, wherein said fastener is separated from said spider, said diaphragm and said diaphragm support.

8. The loudspeaker of claim 6, wherein said fastener is a cylindrical body having two opposite ends and formed with a retaining channel that extends in a longitudinal direction from one of said opposite ends to the other of said opposite ends, said section of each of said speaker tinsel conductors being sheathed with an insulator sheath, said sections of said speaker tinsel conductors extending fittingly in said longitudinal direction through said retaining channel.

9. The loudspeaker of claim 6, wherein said fastener is a cylindrical body having two opposite ends and formed with two spaced apart retaining channels that extend in a longitudinal direction from one of said opposite ends to the other of said opposite ends, said sections of said speaker tinsel conductors extending in said longitudinal direction through said retaining channels, respectively.

10. The loudspeaker of claim 6, wherein said fastener is a cylindrical body having two opposite ends, and an outer surface that is formed with two opposing retaining channels indented inwardly of said outer surface and extending in a longitudinal direction from one of said opposite ends to the other of said opposite ends, said sections of said speaker tinsel conductors extending in said longitudinal direction through said retaining channels, respectively.

11. The loudspeaker of claim 6, wherein said wire stabilizer includes a plurality of said fasteners that interconnect said sections of said speaker tinsel conductors.

12. A method for preventing twisting and collision between a pair of spaced apart speaker tinsel conductors in a loudspeaker which includes a magnet assembly, a vibration unit operably associated with the magnet assembly so as to vibrate upon receiving an electrical signal, and a spider connected to the vibration unit so as to maintain proper position of the vibration unit without hindering free vibration of the vibration unit, the speaker tinsel conductors being free of contact with the spider and being electrically connected to the vibration unit, the method comprising the step of:
interconnecting the speaker tinsel conductors using a fastener in the loudspeaker in a manner that the fastener is separated from the vibration unit and the spider.
